(19) United States
(12) Patent Application Publication
(10) Pub. No.: US 2016/0327697 A1
(43) Pub. Date: Nov. 10, 2016

(54) PROCESS FOR PRODUCTION OF ANISOTROPIC OPTICAL FILM

(71) Applicant: Tomoegawa Co., Ltd., Tokyo (JP)

(72) Inventor: Masahide SUGIYAMA, Shizuoka-shi (JP)

(21) Appl. No.: 15/084,707

(22) Filed: Mar. 30, 2016

(30) Foreign Application Priority Data
Mar. 31, 2015 (JP) 2015-074046

(51) Int. Cl. G02B 5/02; B29D 11/00; B29C 47/00

(52) U.S. Cl. CPC G02B 5/0257; G02B 5/0236; B29C 47/0021; B29D 11/00634

(57) ABSTRACT

A process for producing an anisotropic optical film of which diffusibility is varied depending on the incident angle of light includes: —a light irradiation mask joining step of joining a light irradiation mask with a haze value of 1.0 to 50.0% to a surface of an uncured light-curing resin composition layer; and a curing step of curing the uncured resin composition layer to form an anisotropic diffusion layer by light irradiation through the light irradiation mask, after the light irradiation mask joining step.

### TECHNICAL FIELD

The present invention relates to a process for producing an anisotropic optical film of which the diffusibility of transmitted light is varied depending on the incident angle.

### BACKGROUND ART

Members that have a light diffusibility are also used in display devices, besides lighting equipment and building materials. The displays include, for example, liquid crystal display devices (LCD) and organic electroluminescence elements (organic EL). Light diffusing mechanisms of light diffusion members include mechanism based on diffusion caused by asperity formed at the surface (surface diffusion), diffusion caused by a refractive index difference between a matrix resin and fine particles dispersed therein (internal diffusion), and both surface diffusion and internal diffusion. However, these light diffusion members typically have isotropic diffusion performance, and even when the incident angle of light is somewhat varied, diffusion characteristics of the transmitted light have not varied greatly.

On the other hand, anisotropic optical films are known which are able to diffuse incident light in a certain angle region and transmit incident light in the other angle region, that is, vary the linear transmitted light quantity depending on incident light. As such an anisotropic optical film, an anisotropic diffusion medium is disclosed where an aggregate of multiple pillar-like cured regions all extending parallel to a predetermined direction P is formed within a resin layer composed of a cured product of a composition including a photo-polymerizable compound (for example, see JP 2005-265915 A). It is to be noted that the structure of an anisotropic optical film where an aggregate of multiple pillar-like cured regions extending parallel to the predetermined direction P is formed as described in JP 2005-265915 A will be hereinafter referred to as a “columnar structure” in this specification.

In the anisotropic optical film which has the columnar structure, when there is light incident on the film from top toward bottom, there is identical diffusion in a flow direction in the film manufacturing process (hereinafter, referred to as an “MD direction”) and in a film width direction perpendicular to the MD direction (hereinafter, referred to as a “TD direction”). More specifically, diffusion is isotropic in the anisotropic optical film which has the columnar structure. Therefore, the anisotropic optical film which has the columnar structure is unlikely to cause a rapid change in brightness or cause glare. In addition, because of the columnar structure, the linear transmittance has a tendency to be lower than that of a tabular structure.

On the other hand, rather than the columnar structure mentioned above, the use of an anisotropic optical film where an aggregate of one or more plate-like cured regions is formed within a resin layer composed of a cured product of a composition including a photo-polymerizable compound (see, for example, Japanese Patent No. 4802707) as an anisotropic optical film can improve the linear transmittance in a non-diffusion region to increase the diffusion width. It is to be noted that the structure of an anisotropic optical film where an aggregate of one or more plate-like cured regions is formed as described in Japanese Patent No. 4802707 will be hereinafter referred to as a “tabular structure” in this specification.

In the anisotropic optical film which has the tabular structure, when there is light incident on the film from top toward bottom, there is a difference in diffusion between the MD direction and the TD direction. More specifically, diffusion is anisotropic in the anisotropic optical film which has the tabular structure. Specifically, for example, the width (diffusion width) of a diffusion region is made larger than that of the columnar structure in the MD direction, the diffusion width is made smaller than that of the columnar structure in the TD direction. Therefore, in the anisotropic optical film which has the tabular structure is likely to cause, for example, when the diffusion width is decreased in the TD direction, light interference, and thus glare as a result of causing a rapid change in brightness in the TD direction. In addition, because of the tabular structure, the linear transmittance has a tendency to be higher than that of a columnar structure.

With these problems as challenges, JP 2012-11709 A discloses an anisotropic optical film that has an intermediate structure between the columnar structure and the tabular structure. This structure of the anisotropic optical film will be referred to as a “tabular pillarlike structure”. This patent literature adopts, as an approach for obtaining a tabular pillarlike structure, a method of uniaxially stretching a thin plate-like photo-polymerizable cured product including multiple pillar structures along the surface of the thin plate, thereby uniaxially extending the cross-sectional shapes of the pillar structures.

Patent Literature 1: JP 2005-265915 A

Patent Literature 2: Japanese Patent No. 4802707

Patent Literature 3: JP 2012-11709 A

### DISCLOSURE OF THE INVENTION

### Problems to be Solved by the Invention

As just described, anisotropic optical films (light control films) have been developed in various forms, depending on their functions and intended uses. However, in the anisotropic optical films described in JP 2005-265915 A, Japanese Patent No. 4802707, and JP 2012-11709 A, at manufacturing stages therefor, a non-structural region that is a layer of cured resin without any structural region is formed on the structural region (the layer of the pillar-like cured regions) present within the resin layer (the structural region and the non-structural region will be described later). When there are such non-structural regions, desired optical characteristics with respect to specific film thicknesses fail to be achieved in some cases, because the non-structural regions have no optical function. In addition, while such a problem is resolved when this non-structural region is ground, grinding the non-structural region may result in inferior in terms of productivity and cost.

Therefore, an object of the present invention is to provide a method for manufacturing an anisotropic optical film, which provides an anisotropic optical film with desired optical characteristics with respect to a specific film thickness, even without grinding a non-structural region, by suppressing the formation of the non-structural region in manufacturing the anisotropic optical film.

### Means for Solving the Problems

The inventors have earnestly made researches in order to solve the problems mentioned above. As a result, the inventors have found that the formation of a non-structural region in a curing step is suppressed by providing a step of joining a specific coating member onto a light-curing resin composition as a stage before the curing step of curing the light-curing resin composition to form a light-curing resin layer, thereby achieving the present invention. More specifically, the present invention is as follows:

The present invention (1) is a process for producing an anisotropic optical film of which the diffusibility of transmitted light is varied depending on the incident angle of light, including: a light irradiation mask joining step of joining a light irradiation mask with a haze value of 1.0 to 50.0% to a surface of an uncured light-curing resin composition layer; and a curing step of curing the uncured resin composition layer to form an anisotropic diffusion layer by light irradiation through the light irradiation mask, after the light irradiation mask joining step.

The present invention (2) is the process for producing an anisotropic optical film according to the invention (1), wherein the light irradiation mask has ultraviolet permeability, and a resin material for the light irradiation mask includes at least one of polyolefins, polyesters, poly(meth)acrylates, polycarbonates, polyvinyl acetates, polyvinyl alcohols, polyamides, polyurethanes, polysilicone, polyvinyl chloride, polyvinylidene chloride, polystyrene, polyacrylonitrile, polybutadiene, and polyacetal.

The present invention (3) is the process for producing an anisotropic optical film according to the invention (1) or (2), wherein the light irradiation mask has surface roughness of 0.05 to 0.50 μm.

The present invention (4) is the process for producing an anisotropic optical film according to any of the inventions (1) or (2), wherein the light irradiation mask has a thickness of 1 to 100 μm.

The present invention (5) is the process for producing an anisotropic optical film according to any of the inventions (1), (2) or (4), wherein the light irradiation mask has an oxygen permeation coefficient of 1.0×10⁻¹¹ cm³ (STP) cm/(cm²·s·Pa) or less.

The present invention (6) is the process for producing an anisotropic optical film according to any of the inventions (1) or (2), wherein the anisotropic diffusion layer includes a matrix region and a plurality of pillar regions that differ in light refractive index from the matrix region.

The present invention (7) is the process for producing an anisotropic optical film according to any of the inventions (1) to (3), wherein the light irradiation mask contains fine particles, and the fine particles are 10 μm or less in average particle size.

The present invention (8) is the process for producing an anisotropic optical film according to the invention (7), wherein the fine particles include at least one or more inorganic fine particles selected from the group consisting of a metal particle, a metal oxide particle, a clay, and a carbide particle.

In this regard, the definitions of respective terms in the present invention will be described.

The “light” in the present invention refers to electromagnetic waves including visible light of wavelengths from 380 nm to 780 nm and ultraviolet light of wavelengths from 100 nm to 400 nm.

The terms of “low refractive index region” and “high refractive index region” refer to regions formed from a local difference between higher and lower refractive indexes of the material constituting the anisotropic optical film, and indicate that the refractive index is relatively lower or higher as compared with the other. These regions are formed in curing the material that forms the anisotropic optical film.

The linear transmittance refers to, in regard to the linear transmission of light incident onto the anisotropic optical film, the ratio between the amount of light transmitted in a linear direction and the amount of incident light in the case of incidence from a certain incident angle, which is represented by the following formula:

Linear Transmittance (%)=(Linear transmitted light quantity/Amount of Incident Light)×100

### Effect of the Invention

The present invention makes it possible to provide a method for manufacturing an anisotropic optical film, which provides an anisotropic optical film with desired optical characteristics with respect to a specific film thickness, even without grinding a non-structural region.

### BRIEF DESCRIPTION OF DRAWINGS

FIG. 1A is an operation diagram of a process for producing an anisotropic optical film according to the present embodiment, and FIG. 1B is an operation diagram of a process for producing an anisotropic optical film according to the prior art;

FIG. 2A is a conceptual diagram of an anisotropic optical film according to the present embodiment, and FIG. 2B is a conceptual diagram of an anisotropic optical film according to the prior art;

FIG. 3 is a conceptual diagram in connection with a method for measuring a diffusion width of an anisotropic optical film according to the present embodiment;

FIGS. 4A and 4B are conceptual diagrams illustrating an example of a sample structure for use in the measurement of a diffusion width of an anisotropic optical film according to the present embodiment;

FIGS. 5A and 5B are conceptual diagrams illustrating an example of a sample structure for use in the measurement of a diffusion width of an anisotropic optical film according to the present embodiment;

FIG. 6 is a photograph of a cross section of an anisotropic optical film according to Example 1;

FIG. 7 is a photograph of a cross section of an anisotropic optical film according to Example 3; and

FIG. 8 is a photograph of a cross section of an anisotropic optical film according to Comparative Example 1.

### BEST MODE FOR CARRYING OUT THE INVENTION

While an anisotropic optical film and a producing process therefor according to the present invention will be described below, the present invention is not to be considered limited to the embodiment therein. In addition, the anisotropic optical film according to the present invention is indented to make it possible to form an anisotropic diffusion layer which has no non-structural region formed (is unlikely to have a non-structural region formed) through the use of a particular light irradiation mask in a step for producing the film, and the particular light irradiation mask is widely applicable to conventional anisotropic optical films. Accordingly, the concept of the present invention is considered to also encompass therein cases of applying the light irradiation mask according to the present invention to known process for producing anisotropic optical films as in, for example, JP 2005-265915 and JP 2009-150971.

### <<Structure of Anisotropic Optical Film>>

### <Overall Structure>

The anisotropic optical film according to the present embodiment has at least an anisotropic diffusion layer.

### [Anisotropic Diffusion Layer]

The anisotropic diffusion layer according to the present embodiment will be described while being compared with an anisotropic diffusion layer according to the prior art.

The anisotropic optical film according to the present embodiment has, as the anisotropic diffusion layer (single continuous layer), a layer composed of a light-curing resin composition (light-curing resin composition layer). The light-curing resin composition layer is a layer composed of a light-curing resin composition cured by light (for example, ultraviolet light). Further, the light-curing resin composition layer has a number (infinite number) of pillar regions (pillar bodies) oriented in a direction that penetrates the layer, which is formed in a planar direction. Furthermore, in the anisotropic diffusion layer, a layer with such pillar regions (a region with pillar regions present on a cross section when the anisotropic diffusion layer is viewed in the cross section parallel to the layer) is regarded as a structural region, whereas a layer without such pillar regions (a region with no pillar regions present on a cross section when the anisotropic diffusion layer is viewed in the cross section parallel to the layer) is regarded as a non-structural region. It is to be noted that the “pillar regions” refer to minute pillar-like light-curing resin composition regions that slightly differ in refractive index from the peripheral region. In addition, the light-curing resin composition region in the anisotropic diffusion layer, other than the “pillar regions”, is regarded as a matrix region. As just described, the refractive index of the pillar regions may be different from the refractive index of the matrix region, but how the refractive index is different is not particularly limited, and considered relative. When the refractive index of the matrix region is lower than the refractive index of the pillar regions, the matrix region serves as a low refractive index region. In contrast, when the refractive index of the matrix region is higher than the refractive index of the pillar regions, the matrix region serves as a high refractive index region.

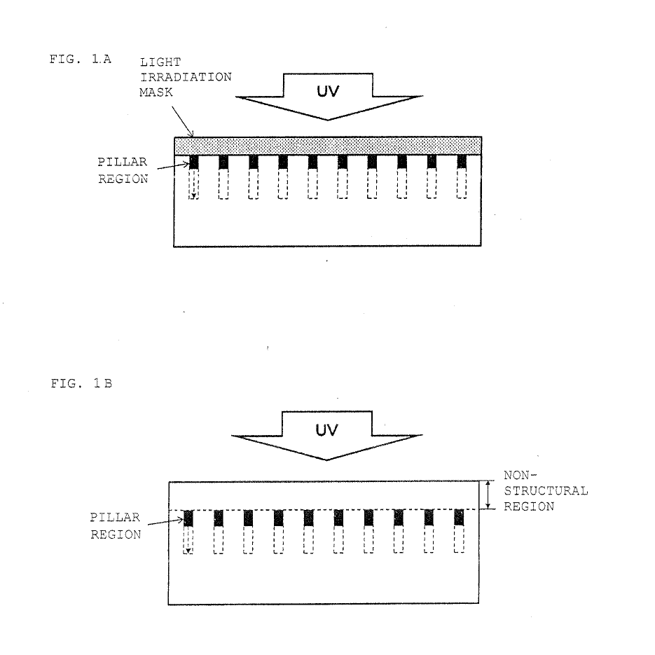

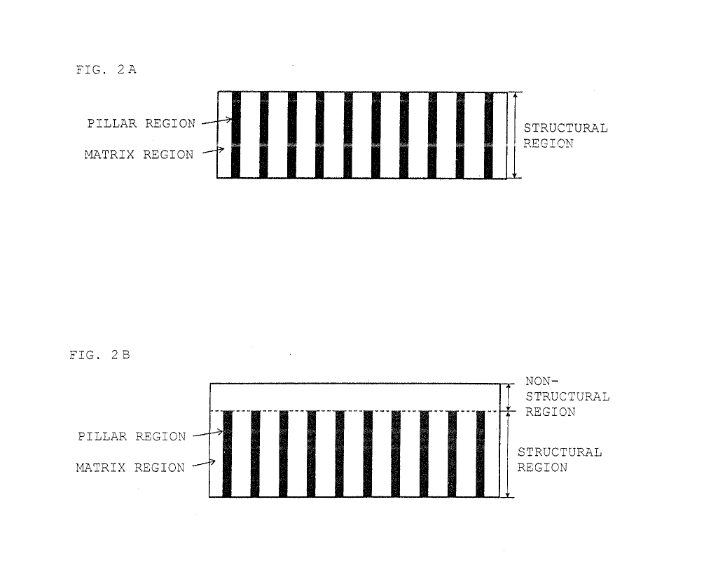

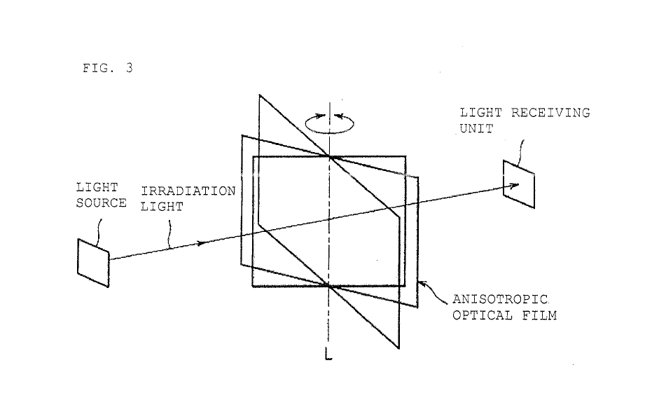

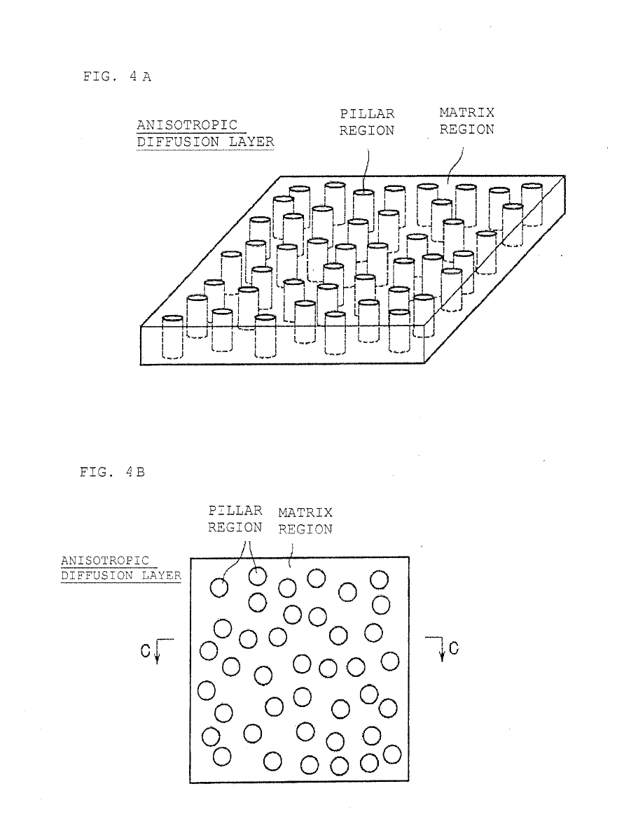

Next, structural features of the anisotropic diffusion layer according to the present embodiment will be described with reference to FIGS. 1A and 1B and FIGS. 2A and 2B.

FIGS. 1B and 2B are an operation diagram and a conceptual diagram for an anisotropic optical film (in particular, anisotropic diffusion layer) and a producing process therefor according to the prior art. As shown in the figures, when attention is focused on a layer cross section of the light-curing resin composition layer as shown in the figures, the layer cross section has a structural region formed, with a number (infinite number) of pillar regions formed to be oriented in a direction that penetrates the layer. On the other hand, a non-structural region is formed in the anisotropic diffusion layer by the producing process according to the prior art. This non-structural region is able to be removed by grinding, but such a case is worse in terms of cost and productivity.

Next, FIGS. 1A and 2A are an operation diagram and a conceptual diagram for an anisotropic optical film (in particular, anisotropic diffusion layer) and a producing process therefor according to the present embodiment. The anisotropic diffusion layer according to the present embodiment has a structural region formed as with the anisotropic optical film according to the prior art, but on the other hand, has no non-structural region formed (or is not likely to have a non-structural region formed), unlike the anisotropic optical film according to the prior art. As just described, in accordance with the process for producing an anisotropic optical film according to the present embodiment, although the principle will be described later, providing a particular light irradiation mask (which will be described later) in a curing step makes it possible to achieve an anisotropic diffusion layer without any non-structural region (or with an extremely thin non-structural region of preferably 20 μm or less, more preferably 5 μm or less).

### (Pillar Region)

Known structures are conceivable as specific structures of the pillar regions included in the anisotropic diffusion layer. In this regard, the pillar regions are limited to the previously mentioned columnar structures, but may have a tabular pillarlike shape as described previously. In addition, the pillar regions need not extend straight in a direction that penetrates the anisotropic diffusion layer, may have an appropriate slope. It is to be noted that the slope of the pillar region means a direction that is coincident with the incident angle of light of which scattering characteristics have substantial symmetry with respect to the incident angle when the incident angle is varied. The phrase of “having substantial symmetry” is used herein because the optical characteristics have no exact symmetry. The slope of the pillar region can be found by observing the slope of a film cross section with an optical microscope, or observing the projection profile of light through the anisotropic optical film while varying the incident angle. It is to be noted that such a specific shape of the pillar regions is able to be appropriately changed by changing, at a stage of producing the region, conditions in accordance with a conventional producing process or the like.

### (Thickness)

The thickness of the anisotropic diffusion layer according to the present embodiment is not particularly limited, but preferably 20 to 100 μm, and more preferably 25 to 55 μm. The anisotropic diffusion layer according to the present embodiment has no non-structural region formed at any stage of manufacturing the layer, and thus has an excellent light diffusibility even with its small thickness, when the layer is adopted as an anisotropic optical film.

### [Other Layers]

The anisotropic optical film may have other layer provided on one side of the anisotropic diffusion layer. The other layers can include, for example, pressure-sensitive adhesive layers, polarization layers, light diffusion layers, low-reflection layers, antifouling layers, antistatic layers, ultraviolet-near-infrared-rays (NIR) absorption layers, neon cut layers, and electromagnetic shielding layers. The other layers may be sequentially stacked. Other layers may be stacked on both sides of the anisotropic diffusion layer. The other layers stacked on the both sides may be layers that have the same function, or layers that have different functions.

### <<Process for Producing Anisotropic Optical Film>>

The anisotropic optical film according to the present embodiment is also able to be provided by coating or the like directly on a reflective base material or an isotropic diffusion medium, but can be also bonded with a pressure-sensitive adhesive agent or an adhesive agent through a normal processing technique. In addition, for example, also in the case of bonding the anisotropic optical film according to the present embodiment and a flexible support or board to each other, it is preferable to use a pressure-sensitive adhesive agent or an adhesive agent. It will be obvious that when the flexible support or board itself is reflective, the anisotropic optical film can be stacked directly on the reflective surface. Raw materials for the anisotropic diffusion layer will be first described below, and steps for manufacturing the layer will be then described.

### <Raw Materials for Anisotropic Diffusion Layer>

### [Light-Curing Resin Composition]

The light-curing resin composition that is an essential material for forming the anisotropic diffusion layer according to the present embodiment is composed of: a photo-polymerizable compound selected from polymers, oligomers, and monomers having a radical-polymerizable or cationic-polymerizable functional group; and a photoinitiator, and is a material that is polymerized and solidified through ultraviolet and/or visible light irradiation.

### (Photo-Polymerizable Compound)

The radical polymerizable compounds are each mainly a compound having, in the molecule thereof, one or more unsaturated double bonds. Specific examples thereof include acrylic oligomers called through respective names of epoxy acrylate, urethane acrylate, polyester acrylate, polyether acrylate, polybutadiene acrylate, and silicone acrylate; and acrylic monomers such as 2-ethylhexyl acrylate, isoamyl acrylate, butoxyethyl acrylate, ethoxydiethylene glycol acrylate, phenoxyethyl acrylate, tetrahydrofurfuryl acrylate, isonorbornyl acrylate, 2-hydroxyethyl acrylate, 2-hydroxypropyl acrylate, 2-acryloyloxy phthalate, dicyclopentenyl acrylate, triethylene glycol diacrylate, neopentyl glycol diacrylate, 1,6-hexanediol diacrylate, an EO adduct diacrylate of bisphenol A, trimethylolpropane triacrylate, EO-modified trimethylolpropane triacrylate, pentaerythritol triacrylate, pentaerythritol tetraacrylate, ditrimethylolpropane tetraacrylate, and dipentaerythritol hexaacrylate. These compounds may be used alone, or in the form of a mixture of two or more thereof. In the same way, a methacrylate is usable. In general, acrylates are larger in photopolymerization rate than methacrylates, and thus the formers are preferred.

The cation polymerizable compounds may each be a compound having in the molecule thereof one or more selected from epoxy, vinyl ether and oxetane groups. Examples of the compound having epoxy groups include 2-ethylhexyl diglycol glycidyl ether, glycidyl ether of biphenyl, any diglycidyl ether of a bisphenol such as bisphenol A, hydrogenated bisphenol A, bisphenol F, bisphenol AD, bisphenol S, tetramethylbisphenol A, tetramethylbisphenol F, tetrachlorobisphenol A, or tetrabromobisphenol A; any polyglycidyl ether of a novolak resin such as phenol novolak, cresol novolak, brominated phenol novolak, or o-cresol novolak; any diglycidyl ether of an alkylene glycol such as ethylene glycol, polyethylene glycol, polypropylene glycol, butanediol, 1,6-hexanediol, neopentyl glycol, trimethylolpropane, 1,4-cyclohexanedimethanol, an EO adduct of bisphenol A, or a PO adduct of bisphenol A; and glycidyl esters such as a glycidyl ester of hexahydrophthalic acid, and a diglycidyl ester of dimer acid.

Additional examples of the compound having epoxy groups include alicyclic epoxy compounds such as 3,4-epoxycyclohexylmethyl 3′,4′-epoxycyclohexanecarboxylate, 2-(3,4-epoxycyclohexyl-5,5-spiro-3,4-epoxy)cyclohexane-meta-dioxane, di(3,4-epoxycyclohexylmethyl) adipate, di(3,4-epoxy-6-methylcyclohexylmethyl) adipate, 3,4-epoxy-6-methylcyclohexyl-3′,4′-epoxy-6′-methyl cyclohexanecarboxylate, methylenebis(3,4-epoxycyclohexane), dicyclopentadiene diepoxide, di(3,4-epoxycyclohexylmethyl)ether of ethylene glycol, ethylenebis(3,4-epoxycyclohexanecarboxylate, lactone-modified 3,4-epoxycyclohexylmethyl-3′,4′-epoxycyclohexanecarboxylate, tetra(3,4-epoxycyclohexylmethyl) butanetetracarboxylate, and di(3,4-epoxycyclohexylmethyl)-4,5-epoxytetrahydrophthalate. However, the compound is not limited to these examples.

Examples of the compound having vinyl ethers include diethylene glycol divinyl ether, triethylene glycol divinyl ether, butanediol divinyl ether, hexanediol divinyl ether, cyclohexanedimethanol divinyl ether, hydroxybutyl vinyl ether, ethyl vinyl ether, dodecyl vinyl ether, trimethylolpropane trivinyl ether, and propenyl ether propylene carbonate. However, the compound is not limited to these examples. The vinyl ether compound is generally a cation polymerizable. However, when combined with an acrylate, the vinyl ether compound is radical-polymerizable.

In addition, examples of the compound having oxetane groups include 1,4-bis[(3-ethyl-3-oxetanylmethoxy)methyl]benzene, and 3-ethyl-3-(hydroxymethyl)-oxetane.

It is to be noted that the foregoing cationic-polymerizable compounds may be each used singly, or may be used in mixture. The photo-polymerizable compound mentioned above is not to be considered limited to the foregoing. In addition, in order to produce a sufficient difference in refractive index, fluorine atoms (F) may be introduced into the photo-polymerizable compound for making a decrease in refractive index, and sulfur atoms (S), bromine atoms (Br), various types of metal atoms may be introduced into the compound for making an increase in refractive index. In addition, as disclosed in JP 2005-514487 A, it is also effective to add, to the photo-polymerizable compound mentioned above, functional ultrafine particles obtained by introducing a photo-polymerizable functional group such as an acrylic group, a methacrylic group or an epoxy group onto the surfaces of ultrafine particles composed of a metal oxide with a high refractive index, such as titanium oxide (TiO₂), zirconium oxide (ZrO₂), or tin oxide (SnOx).

### (Photoinitiator)

Photoinitiators that can cause the radical-polymerizable compound to be subjected to polymerization include benzophenone, benzyl, Michler's ketone, 2-chlorothioxantone, 2,4-diethyithioxantone, benzoin ethyl ether, benzoin isopropyl ether, benzoin isobutyl ether, 2,2-diethoxyacetophenone, benzyl dimethyl ketal, 2,2-dimethoxy-1,2-diphenylethane-1-on, 2-hydroxy-2-methyl-1-phenylpropane-1-on, 1-hydroxycyclohexyl phenyl ketone, 2-methyl-1-[4-(methylthio)phenyl]-2-morpholinopropanone-1, 1-[4-(2-hydroxyethoxy)-phenyl]-2-hydroxy-2-methyl-1-propane-1-on, bis(cyclopentadienyl)-bis(2,6-difluoro-3-(pyl-1-yl)titanium, 2-benzyl-2-dimethylamino-1-(4-morpholinophenyl)-butanone-1, and 2,4,6-trimethylbenzoyldiphenylphosphine oxide. In addition, these compounds may be each used singles, or may be used in mixture.

In addition, a photoinitiator for the cationic-polymerizable compound is a compound that generates an acid by light irradiation and causes the above-mentioned cationic-polymerizable compound to be subjected to polymerization with the generated acid, for which typically, an onium salt or a metallocene complex is used in a preferred manner. As the onium salt, a diazonium salt, a sulfonium salt, an iodonium salt, a phosphonium salt, a selenium salt, or the like is used, and anion such as BF₄⁻, PF₆⁻, AsF₆⁻, or SbF₆⁻ is used for the counterion. Specific examples include, but not limited thereto, 4-chlorobenzenediazonium hexafluorophosphate, triphenylsulfonium hexafluoroantimonate, triphenylsulfonium hexafluorophosphate, (4-phenylthiophenyl)diphenylsulfonium hexafluoroantimonate, (4-phenylthiophenyl)diphenylsulfonium hexafluorophosphate, bis[4-(diphenylsulfonio)phenyl]sulfide-bis-hexafluoroantimonate, bis[4-(diphenylsulfonio)phenyl]sulfide-bis-hexafluorophosphate, (4-methoxyphenyl)diphenylsulfonium hexafluoroantimonate, (4-methoxyphenyl)diphenyliodonium hexafluoroantimonate, bis(4-t-butylphenyl)iodonium hexafluorophosphate, benzyltriphenylphosphonium hezafluoroantimonate, triphenylselenium hexafluorophosphate, and (η5-isopropylbenzene) (η5-cyclopentadienyl)iron (II). In addition, these compounds may be each used singles, or may be used in mixture.

### (Blend Proportions, Other Optional Component)

In the present embodiment, the previously mentioned photoinitiator is combined on the order of 0.01 to 10 parts by weight, preferably 0.1 to 7 parts by weight, more preferably 0.1 to 5 parts by weight with respect to 100 parts by weight of the photo-polymerizable compound. This is because the combination of less than 0.01 parts by weight decreases the light-curing performance, whereas the adverse effect of internal curing performance decreased with only the surface cured, coloring, or blocked formation of pillar regions is caused in the case of being combined in excess of 10 parts by weight. These photoinitiators are used typically by dissolving powders of the photoinitiators directly in the photo-polymerizable compound, but when the solubility is poor, the photoinitiators can be also dissolved in high concentrations in extremely small amounts of solvent in advance, and used. This solvent is further preferably photo-polymerizable, and specifically, examples of the solvent include propylene carbonate and γ-butyrolactone. In addition, it is also possible to add various types of known dyes and sensitizers in order to improve the photo-polymerizable property. Furthermore, a thermosetting initiator that can cure the photo-polymerizable compound by heating can be also used in combination with the photoinitiator. In this case, the polymerization and curing of the photo-polymerizable compound can be expected to be further accelerated and completed by heating after light curing.

According to the present embodiment, the anisotropic diffusion layer can be formed by curing the light-curing resin composition alone, or composition that has more than one composition mixed. Alternatively, a mixture of the light-curing resin composition with a polymeric resin that has no light-curing performance may be used. Polymeric resins that can be used herein include acrylic resins, styrene resins, styrene-acrylic copolymers, polyurethane resin, polyester resins, epoxy resins, cellulosic resins, vinyl acetate resins, vinyl chloride-vinyl acetate copolymers, and polyvinyl butyral resins. There is a need for the polymeric resin and the light-curing resin composition to have adequate compatibility before the light curing, it is also possible to use various types of organic solvents, plasticizers, and the like in order to ensure the compatibility. It is to be noted that in the case of using an acrylate as the light-curing resin composition, it is preferable to select the polymeric resin from the acrylic resins in terms of compatibility.

### <Steps>

As a process for producing the anisotropic diffusion layer, the light-curing resin composition is applied or provided in the form of a sheet onto an appropriate base material film (application step), if necessary, dried to volatilize the solvent, a light irradiation mask is provided on the light-curing resin composition (light irradiation mask joining step), a light source is further disposed on the light irradiation mask, and the light-curing resin composition is irradiated with light through the light irradiation mask from the light source (curing step), thereby making it possible to prepare an anisotropic optical film. The respective steps will be described in detail below.

### [Application Step]

Onto the base material film, an uncured light-curing resin composition is applied, or provided in the form of a sheet to form an uncured resin composition layer.

In this regard, a normal coating method or printing method is applied as an approach for providing the light-curing resin composition on the base material film. Specifically, the method may be, for example, a coating such as air doctor coating, bar coating, blade coating, knife coating, reverse coating, transfer roll coating, gravure roll coating, kiss coating, cast coating, spray coating, slot orifice coating, calender coating, dam coating, dip coating, or die coating; an intaglio printing such as gravure printing; a stencil printing such as screen printing; or some other printing. In addition, when the light-curing resin composition has a low viscosity, for example, a partition of a curing resin may be formed with the use of a dispenser along an edge on which the anisotropic diffusion layer is to be formed, and the uncured light-curing resin composition may be cast in the space surrounded by the partition.

In this regard, the base material film is not limited in any way as long as the film is used such that curing of the light-curing resin composition is not inhibited in the curing step or the like described later, and for example, an appropriate film such as a transparent PET film can be used.

### [Light Irradiation Mask Joining Step]

Next, the light irradiation mask is joined onto (brought into contact with) the uncured resin composition layer formed in the application step. Properties and the like of the light irradiation mask for use in the present step will be described in detail below.

### (Haze Value of Light Irradiation Mask)

The haze value (total haze) of the light irradiation mask is 1.0 to 50.0%, preferably 2.0 to 35.0, and further preferably 10.0 to 25.0%. The haze of the light irradiation mask in this range is believed to cause incident light to have a fine intensity distribution, which produces a difference in reactivity in a microscopic region near the surface of the light-curing resin composition on the light irradiation mask side, and triggers the formation of a structural region. Therefore, excessively low haze results in failure to trigger the formation of a structural region, thereby producing a non-structural region in the anisotropic optical film. On the other hand, excessively high haze causes, in the first place, parallel rays for resin curing to diffuse excessively, thus resulting in failure to obtain a structural region.

In the adjustment of the haze value of the light irradiation mask, an appropriate method may be used, and it is possible to make an adjustment to the value, for example, by changing the raw material for or thickness of the light irradiation mask, or combining fine particles (for example, appropriate fine particles such as carbon, polystyrene, or silica, which will be described later) and changing the blend proportion or the like of the fine particles.

In this regard, the haze value of the light irradiation mask refers to a value measured in accordance with the JIS K7136: 2000 with the use of a haze meter NDH-2000 from NIPPON DENSHOKU INDUSTRIES CO., LTD.

### (Arithmetic Average Roughness (Ra) of Light Irradiation Mask)

The arithmetic average roughness (Ra) of the surface of the light irradiation mask in contact with the light-curing resin composition is preferably 0.05 to 0.50 μm, more preferably 0.05 to 0.25 μm, and further preferably 0.10 to 0.15 μm. The light irradiation mask is joined to (brought into contact with) the light-curing resin composition (uncured light-curing resin composition) that forms the anisotropic diffusion layer, and thus affects glare and roughness on the anisotropic diffusion layer (anisotropic optical film). Therefore, the excessively low arithmetic average roughness (Ra) of the light irradiation mask makes glare more likely to be caused, whereas the excessively high arithmetic average roughness makes roughness more likely to be increased.

In this regard, the arithmetic average roughness (Ra) of the light irradiation mask refers to a value measured in accordance with the JIS B0601: 1994 with the use of surfcorder SE1700α from Kosaka Laboratory Ltd.

### (Thickness of Light Irradiation Mask)

The thickness of the light irradiation mask according to the present embodiment is preferably 1 to 100 μm, and more preferably 5 to 20 μm. The thickness of the light irradiation mask affects the unevenness defect of the anisotropic diffusion layer, and the excessively thick light irradiation mask makes the anisotropic diffusion layer more likely to have plaques and defects caused, whereas the excessively thin mask makes it difficult to handle the mask in actual manufacturing steps.

In this regard, the thickness of the light irradiation mask refers to the average of values measured with a micrometer from Mitutoyo Corporation {N=3, measurement points: (1) a central part in the length direction; (2) a central part between the central part in the length direction and one end in the length direction; and (3) a central part between the central part in the length direction and the other end in the length direction, in the extent of the light irradiation mask joined to the uncured resin composition layer}.

### (Oxygen Permeation Coefficient of Light Irradiation Mask)

The oxygen permeation coefficient of the light irradiation mask is preferably 1.0×10⁻¹¹ cm³ (STP) cm/(cm²·s·Pa) or less, more preferably 1.0×10⁻¹³ cm³ (STP) cm/(cm²·s·Pa) or less, and further preferably 1.0×10⁻¹⁵ cm³ (STP) cm/(cm²·s·Pa) or less. When the oxygen permeation coefficient of the light irradiation mask is excessively high, curing of the surface of the light-curing resin composition {the surface joined to (brought into contact with) the light irradiation mask} fails to proceed, thereby making a non-structural region to be produced. In this regard, “STP” in the above unit is an abbreviation for “Standard and Temperature and Pressure”, converting the oxygen permeation coefficient to a value thereof under standard conditions of 1 atm, zero degrees.

In this regard, the oxygen permeation coefficient of the light irradiation mask refers to a value measured in accordance with the JIS K7126-2: 2006.

### (Ultraviolet Permeability of Light Irradiation Mask)

The light irradiation mask preferably has ultraviolet permeability. More specifically, the ultraviolet permeability (transmittance) of the light irradiation mask is preferably 30 to 100%, and more preferably 70 to 100%. When an ultraviolet curing resin is used as a light-curing resin composition, the excessively low ultraviolet permeability of the light irradiation mask may fail to cause curing to proceed, thereby failing to form a structural region.

In this regard, the ultraviolet permeability of the light irradiation mask (the permeability with respect to ultraviolet of desired wavelengths) refers to a value measured with the use of an UV-VIS spectrophotometer (UV-3100 from Shimadzu Corporation).

### (Raw Material for Light Irradiation Mask)

The raw material for the light irradiation mask is not particularly limited, but for example, at least one resin selected from the group consisting of polyolefins, polyesters, poly(meth)acrylates, polycarbonates, polyvinyl acetates, polyvinyl alcohols, polyamides, polyurethanes, polysilicone, polyvinyl chloride, polyvinylidene chloride, polystyrene, polyacrylonitrile, polybutadiene, and polyacetal. Above all, the polyvinyl alcohols, polyamides, polyvinyl acetates, and polyolefins are more preferred because of their excellent UV permeability and flexibility, in particular, the polyvinyl alcohols, polyamides, and polyvinyl acetates are further preferred because of their low oxygen permeability, and furthermore, the polyvinyl alcohols are most preferred because of their particularly low oxygen permeability.

In addition, the haze of the light irradiation mask can be controlled by combining a resin material that is a raw material for the light irradiation mask, with fine particles.

The fine particles that are able to be combined with the resin material are preferably 10 μm or less in average particle. In the case of an average particle size in excess of 10 μm, the haze is excessively increased, or the arithmetic average roughness of the mask is excessively increased, and the surface smoothness of the anisotropic optical film (anisotropic diffusion layer) will be thus degraded, which may be unfavorable.

It is to be noted that an existing technique such as a Coulter meter and a laser diffraction scattering method can be applied as a method for measuring the average particle size.

In addition, the fine particles may be either inorganic fine particles or organic fine particles, or these inorganic and organic fine particles may be used in mixture.

The inorganic fine particles are not particularly limited, but preferably one or more types of inorganic fine particles selected from the group consisting of metal particles, metal oxide particles, clays, and carbide particles. Specific examples of the inorganic fine particles mainly include: copper, silver, gold, nickel, tin, or stainless steel as the metal particles; zinc oxide, aluminum oxide, magnesium oxide, zirconium oxide, titanium oxide, or silicon oxide (silica) as the metal oxide particles; mica or smectite as the clays; and carbon or graphite as the carbide particles.

In addition, specific examples of the organic fine particles mainly include polystyrene particles, nylon particles, benzoguanamine particles, melamine particles, acrylic particles, silicone particles, or polyimide particles.

The most preferred fine particles in the group of fine particles mentioned above can include carbon as fine particles that have a small particle size, easily disperse, but do not degrade the oxygen permeability, and can achieve a great haze effect (high haze).

The blend proportion of the fine particles is not particularly limited, but the excessively large amount thereof is not preferred because of making it difficult to manufacture the light irradiation mask (mask film) or worsening the oxygen permeation coefficient and haze of the light irradiation mask obtained.

Therefore, the blend proportion of the fine particles is, additionally in consideration of the influence on the haze, preferably 10 parts by weight or less, more preferably 5 parts by weight or less with respect to 100 parts by weight of the resin material.

In addition, in combining the fine particles, the appropriate addition of a dispersant is preferred, and finely dispersing the fine particles with the dispersant can reduced defects in appearance on the anisotropic optical film obtained.

For a method for producing the light irradiation mask of a resin material combined with fine particles, existing techniques can be applied, such as, for example, a solution casting method in which a solution (dope) provided with fluidity by dissolving a material in a solvent is poured and deposited onto a drum (casting drum) with a surface smoothed or a stainless-steel smooth belt, and allowed to go through a heating step to evaporate the solvent, thereby casting a film.

In this regard, as described previously, what is required is that the light irradiation mask is joined onto (brought into contact with) the uncured resin composition layer as the light irradiation mask joining step, and thus, a process or the like may be adopted in which the application step and the light irradiation mask joining step are carried out at the same time, for example, by providing the previously described partition, and filling, with the uncured light-curing resin composition, the space formed by the base material film, the partition, and the light irradiation mask.

### [Curing Step]

Next, the uncured resin composition layer is irradiated with light through the light irradiation mask, thereby curing the uncured resin composition layer, and thus forming an anisotropic diffusion layer (light-curing resin composition layer).

The light source for irradiating the uncured resin composition layer with light varies depending on the light-curing resin composition used, and in the case of using an ultraviolet curing resin composition, a short-arc light source for ultraviolet generation is typically used, and specifically, it is possible to use a high-pressure mercury lamp, a low-pressure mercury lamp, a metal halide lamp, a xenon lamp, or the like.

The light rays with which the uncured resin composition layer is irradiated need to include a wavelength that is able to cure the uncured resin composition layer, and in the case of using an ultraviolet curing resin composition, light of a mercury lamp is typically used which has wavelengths centered on 365 nm. In the case of preparing the anisotropic diffusion layer according to the present embodiment with the use of this wavelength range, the illuminance preferably falls within the range of 0.01 to 100 mW/cm², more preferably within the range of 0.1 to 20 mW/cm². This is because the illuminance of less than 0.01 mW/cm² requires a long period of time for curing, thus worsening the production efficiency, whereas the illuminance in excess of 100 mW/cm² cures the light-curing resin composition too quickly to achieve the structure formation, which may fail to achieve any intended anisotropic diffusion properties.

The UV irradiation time is not particularly limited, but is 10 to 180 seconds, and more preferably 30 to 120 seconds. Thereafter, the anisotropic diffusion layer according to the present embodiment can be obtained by separating the light irradiation mask from the base material film.

The anisotropic diffusion layer according to the present invention is obtained through the formation of pillar regions in the uncured resin composition layer by irradiation with low-illuminance UV light for a relatively long period of time as described above. Therefore, just this light irradiation (UV irradiation) may cause the unreacted monomer component to remain sticky, and have problems with handling ability and durability. In such a case, additional irradiation with high-illuminance light (UV light) of 1000 mW/cm² or more can cause the remaining monomer to polymerize. The light irradiation (UV irradiation) in this case is preferably carried out from the side opposite to the light irradiation mask.

As just described, in the process for producing an anisotropic diffusion layer according to the present embodiment, providing the joining step of joining the particular light irradiation mask to the light-curing resin composition makes it possible to form an anisotropic diffusion layer without any non-structural region. More specifically, the light irradiation mask according to the present embodiment acts, because the light irradiation mask has a particular haze value, as a trigger for the structure formation (pillar region formation) (incident light is provided with a fine intensity distribution), and the action and oxygen hindrance of the light irradiation mask interact with each other, thereby making it possible to form a structural region near the surface of the uncured composition {a non-structural region is not formed (or unlikely to be formed)}. As a result, because there is not any non-structural region that is formed in a conventional method of manufacturing without the use of any mask or a method of manufacturing with the use of a conventional mask (or a non-structural region has a minor layer thickness), a thin film of anisotropic diffusion layer can be efficiently formed, and required optical characteristics can be maintained regardless of the thin film.

### <<Property of Anisotropic Optical Film>>

Next, property (diffusion width) of the anisotropic optical film according to the present invention will be described.

As for the diffusion width of the anisotropic optical film (anisotropic diffusion layer), first, the linear transmittance of light incident on the anisotropic diffusion layer at an incident angle that maximizes the linear transmittance is considered to be defined as a “maximum linear transmittance”, whereas the linear transmittance of light incident on the anisotropic diffusion layer at an incident angle that minimizes the linear transmittance is considered to be defined as a “minimum linear transmittance”.

In this regard, the maximum linear transmittance and the minimum linear transmittance can be adjusted by design parameters at the time of manufacture. Examples of the parameters include the composition of coating film, the film thickness of coating film, and the temperature of coating film, which is applied in the structure formation.

First, as for the composition of coating film, the appropriate selection of composition constituents, adjustment to a combination of the constituents, and the like make it possible to make adjustments to the maximum linear transmittance and the minimum linear transmittance.

Subsequently, as for the film thickness of coating film, there is a tendency for the maximum linear transmittance and the minimum linear transmittance to be more likely to decrease as the film thickness is increased, whereas there is a tendency for the maximum linear transmittance and the minimum linear transmittance to be more likely to increase as the film thickness is reduced, thus making it possible to make adjustments.

Finally, as for the temperature of coating film, there is a tendency for the maximum linear transmittance and the minimum linear transmittance to be more likely to decrease as the temperature is increased, whereas there is a tendency for the maximum linear transmittance and the minimum linear transmittance to be more likely to increase as the temperature is decreased, thus making it possible to make adjustments.

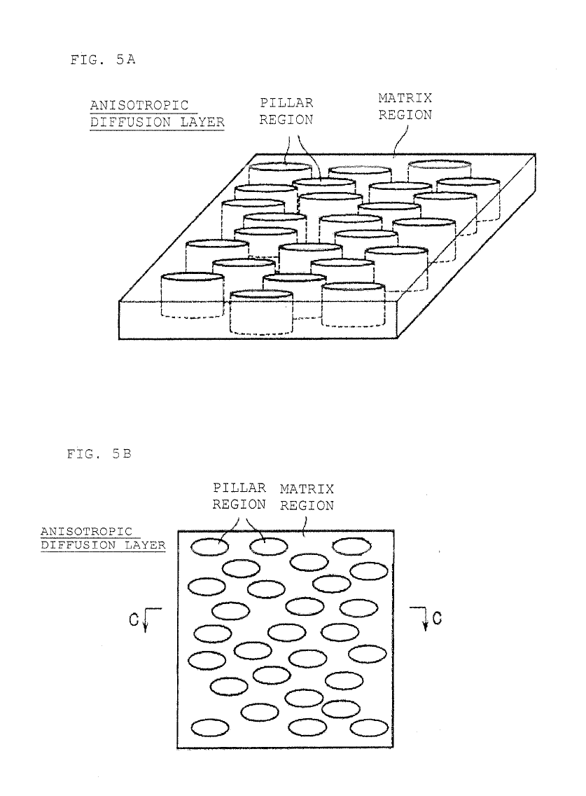

In obtaining the maximum linear transmittance and the minimum linear transmittance, the linear transmitted light quantity and the linear transmittance can be measured by the method shown in FIG. 3. More specifically, the linear transmitted light quantity and linear transmittance were measured for each incident angle (the normal direction is referred to as zero°) in such a way that the rotation axis L shown in FIG. 3 is made coincident with an axis C-C in the anisotropic optical film sample shown in FIG. 4B or FIG. 5B. From the obtained data, an optical profile is obtained, and the maximum linear transmittance and the minimum linear transmittance can be obtained from the optical profile.

The maximum linear transmittance and minimum linear transmittance of the anisotropic optical film are obtained by the approach mentioned above, and the difference is obtained between the maximum linear transmittance and the minimum linear transmittance. A line of intermediate values for the difference is created on the optical profile, two intersections are found out between the line and the optical profile, and incident angles corresponding to the intersections are read off. In the optical profile, the normal direction is referred to as zero°, and the incident angles are indicated in the minus direction and the plus direction. Therefore, incident angles and the incident angles corresponding to the intersections may have negative values. When the two intersections have a positive incident angle value and a negative incident angle value, the sum of the absolute value of the negative incident angle value and the positive incident angle value is referred to as a diffusion width corresponding to a diffusion angle range of incident light.

When the two intersections both have positive values, the difference calculated by subtracting the smaller value from the larger value is referred to as the diffusion width. When the two intersections both have negative values, the difference calculated by obtaining the respective absolute values and subtracting the smaller value from the larger value is referred to as the diffusion width.

The anisotropic optical film according to the present invention preferably has a diffusion width of 35° to 70°. Unfavorably, the diffusion width of less than 35° may result in an insufficient light diffusibility, thereby causing problems, whereas the diffusion width in excess of 70° may damage light condensing properties. The diffusion width is more preferably 40° to 60°.

### <<Intended Use of Anisotropic Optical Film>>

The anisotropic optical film according to the present embodiment can be applied to display devices such as projector screens, liquid crystal display devices (LCD), plasma display panels (PDP), electroluminescence displays (ELD), cathode-ray tube display devices (CRT), surface electric field displays (SED), and electronic papers. In particular, preferably, the film is used for a liquid crystal display device (LCD). In addition, the anisotropic optical film according to the present embodiment can be also bonded to a desired place with an adhesive layer or a pressure-sensitive adhesive layer interposed therebetween, and used. Furthermore, the anisotropic optical film according to the present embodiment can be also used for a transmissive, reflective, or semi-transmissive liquid crystal display device.

### Examples

Anisotropic optical films according to the present invention and anisotropic optical films according to comparative examples were manufactured in accordance with the following methods. It is to be noted that the following anisotropic optical films are each regarded as a film composed of only an anisotropic diffusion layer.

### <Manufacture of Anisotropic Optical Films According to Examples 1 to 11 and Comparative Examples 1 to 3>

With a PET film of 100 μm in thickness and 76×26 mm in size (from Toyobo Co., Ltd., Trade Name: A4100, haze=0.5%) as a base material film, a partition was formed from a light-curing resin composition entirely on a peripheral edge of the film with the use of a dispenser. The partition formed differs among the example, which is shown in Table 1. The height of the partition will generally correspond to the thickness of an anisotropic optical film obtained. The inside of the partition was filled with the following light-curing resin composition, and covered with an UV irradiation mask (light irradiation mask). However, in the case of using no UV irradiation mask according to the comparative examples, the film was used without any covering.
Silicone • Urethane • Acrylate (Refractive Index: 1.460, Weight Average Molecular Weight: 5,890) 20 parts by weight
(from RAHN, Trade Name: 00-225/TM18)
Neopentyl Glycol Diacrylate (Refractive Index: 1.450) 30 parts by weight
(from DAICEL-CYTEC Co., Ltd., Trade Nama: Ebecryl 145)
EO adduct Diacrylate of Bisphenol A (Refractive Index: 1.536) 15 parts by weight
(from Daicel DAICEL-CYTEC Co., Ltd., Trade Nama: Ebecryl 150)
Phenoxyethyl Acrylate (Refractive Index: 1.518) 40 parts by weight
(from Kyoeisha Chemical Co., Ltd., Trade Name: LIGHT ACRYLATE PO-A)
2,2-dimethoxy-1,2-diphenylethane-1-on 4 parts by weight
(from BASF, Trade Name: Irgacure 651)

This liquid film for each thickness, with both sides sandwiched by the films, was placed on a hot plate heated to 80° C., irradiated from the UV irradiation mask side with parallel rays (ultraviolet with a wavelength of 365 nm) emitted from an epi-illumination unit of an UV spot light source (from Hamamatsu Photonics K.K., Trade Name: L2859-01) at an irradiation intensity of 5 mW/cm² for 1 minute, and further irradiated from the base material film side with UV light at an irradiation intensity of 20 mW/cm², thereby providing a completely cured film. Then, the base material film and the UV irradiation mask were separated, thereby providing an anisotropic optical film for each thickness according to the present invention.

### <Measurement of Diffusibility (Haze Value) of Anisotropic Optical Film>

The haze value was measured in accordance with the JIS K7136 with the use of a haze meter NDH-2000 from NIPPON DENSHOKU INDUSTRIES CO., LTD. The increased haze value means that the anisotropic optical film is higher in the diffusibility.

### <Measurement of Diffusion Width of Anisotropic Optical Film>

The anisotropic optical films according to the examples and the comparative examples were evaluated with the use of a variable-angle photometer, goniophotometer that can arbitrarily vary the floodlighting angle of a light source and the light-receiving angle of a light receiving unit (from Genesia Corporation). The light-receiving section was fixed in a position for receiving light that goes straight from the light source, and set in sample holders therebetween were the anisotropic optical films according to the examples and the comparative examples. As shown in FIG. 3, the samples were rotated around a rotation axis (L) to measure the linear transmitted light quantity corresponding to respective incident angles. This evaluation method can evaluate which angular range of incident light diffuses. This rotation axis (L) is the same axis as the axis C-C in the structure (so-called columnar structure) of the sample shown in FIGS. 4A and 4B, or as the axis C-C in the structure (so-called tabular pillarlike structure) of the sample shown in FIGS. 5A and 5B. For the measurement of the linear transmitted light quantity, wavelengths (380 nm to 780 nm) in a visible light range were measured with the use of a luminous efficacy filter. As just described, the “diffusion width” refers to a diffusion angle range of incident light with respect to the linear transmittance as an intermediate value between the maximum linear transmittance and the minimum linear transmittance.

### <Evaluation of Anisotropic Optical Film for Unevenness Defect, Glare, and Roughness>

As for interference (bow) on the anisotropic optical film, transmitted light was observed visually from various angles to evaluate unevenness, glare (interference bow), and roughness.

### <Cross-Section Observation on Anisotropic Optical Film>

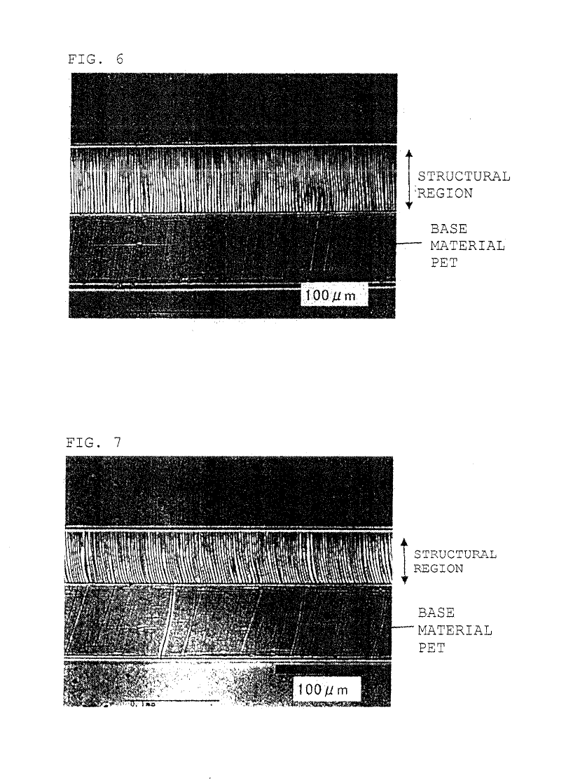

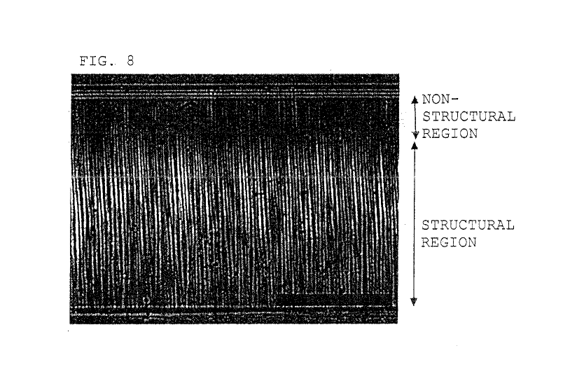

For cross sections of the anisotropic optical films, observation samples of thin sections made through a microtome were observed with an optical microscope at a 200-fold magnification. In the cross-section observation, the thickness of the non-structural region was confirmed. Photographs of cross sections according to Example 1, Example 3, and Comparative Example 1 are shown respectively as FIGS. 6, 7, and 8. In this regard, in the measurement of the thickness of the non-structural region, a line substantially parallel to the outermost part as a layer of the anisotropic optical film was drawn to regard, as the non-structural region, a region where pillar regions in contact with the parallel line account for (the proportion of the length of the parallel line overlapped with the pillar regions is) 50% or less.

The partition heights used in the examples and the comparative examples are shown in Table 1 and Table 1-2. In addition, the material, thickness, haze value, arithmetic average roughness (Ra), oxygen permeation coefficient, and 365 nm ultraviolet permeability of the UV irradiation mask used are shown in Tables 2 through 4. It is to be noted that the haze value, the surface roughness of the surface in contact with the light-curing resin composition, the thickness, the film thickness, the oxygen permeation coefficient, and the ultraviolet permeability of the UV irradiation mask are values measured in accordance with the previously described methods.

TABLE 1

| Partition | Exam- | Exam- | Exam- | Exam- | Exam- | | | | | Comparative | Comparative | Comparative |
|---|---|---|---|---|---|---|---|---|---|---|---|---|
| Property | ple 1 | ple 2 | ple 3 | ple 4 | ple 5 | Example 6 | Example 7 | Example 8 | Example 9 | Example 1 | Example 2 | Example 3 |
| Partition | 100 | 50 | 50 | 50 | 50 | 30 | 30 | 30 | 30 | 190 | 190 | 50 |
| Height | | | | | | | | | | | | |
| (μm) | | | | | | | | | | | | |

TABLE 1-2

| Partition | Exam- | Exam- |
|---|---|---|
| Property | ple 10 | ple 11 |
| Partition | 50 | 50 |
| Height (μm) | | |

TABLE 2

| Properties of UV | Exam- | Exam- | Exam- | Exam- | Exam- |
|---|---|---|---|---|---|
| Irradiation Mask | ple 1 | ple 2 | ple 3 | ple 4 | ple 5 |
| Material | PET | PET | PET | PET | PVA |
| Thickness (μm) | 38 | 38 | 75 | 25 | 10 |
| Haze (%) | 2.5 | 2.5 | 3.8 | 10.7 | 1.3 |
| Arithmetic Average | 0.08 | 0.08 | 0.10 | 0.14 | 0.05 |
| Roughness (Ra) | | | | | |
| Oxygen Permeation | 3.7 × | 3.7 × | 3.9 × | 6.8 × | 4.1 × |
| Coefficient | 10⁻¹⁴ | 10⁻¹⁴ | 10⁻¹⁴ | 10⁻¹² | 10⁻¹⁷ |
| (cm³(STP)cm/ | | | | | |
| (cm² · s · Pa) | | | | | |
| Ultraviolet | 89 | 89 | 85 | 85 | 93 |
| Permeability (%) | | | | | |
| (365 nm) | | | | | |

TABLE 3

| Properties of UV | Exam- | Exam- | Exam- | Exam- |
|---|---|---|---|---|
| Irradiation Mask | ple 6 | ple 7 | ple 8 | ple 9 |
| Material | PET | Carbon | PS | Silica |
| | | Dispersion | Dispersion | Dispersion |
| | | PVA | Acrylic | Nylon |
| Thickness (μm) | 38 | 7 | 12 | 18 |
| Haze (%) | 2.5 | 19.5 | 29.0 | 34.0 |
| Arithmetic Average | 0.08 | 0.15 | 0.25 | 0.37 |
| Roughness (Ra) | | | | |
| Oxygen Permeation | 3.7 × | 2.8 × | 1.6 × | 1.2 × |
| Coefficient | 10⁻¹⁴ | 10⁻¹⁷ | 10⁻¹⁵ | 10⁻¹⁶ |
| (cm³(STP)cm/ | | | | |
| (cm² · s · Pa) | | | | |
| Ultraviolet | 89 | 73 | 86 | 87 |
| Permeability (%) | | | | |
| (365 nm) | | | | |
| Average Particle Size for | — | 0.5 | 5 | 5 |
| Combined Particles (μm) | | | | |

TABLE 3-2

| Properties of UV | Exam- | Exam- |
|---|---|---|
| Irradiation Mask | ple 10 | ple 11 |
| Material | Silica | Graphite |
| | Dispersion | Combined |
| | Silicone | PVA |
| Thickness (μm) | 25 | 25 |
| Haze (%) | 45 | 44 |
| Arithmetic Average | 0.23 | 0.24 |
| Roughness (Ra) | | |
| Oxygen Permeation | 3.5 × | 2.2 × |
| Cofficient | 10⁻¹⁰ | 10⁻¹⁶ |
| (cm³(STP)cm/ | | |
| (cm² · s · Pa) | | |
| Ultraviolet | 70 | 68 |
| Permeability (%) | | |
| (365 nm) | | |
| Average Particle Size for | 5 | 15 |
| Combined Particles (μm) | | |

TABLE 4

| | Compar- | Compar- | Compar- |
|---|---|---|---|
| | ative | ative | ative |
| Properties of UV | Exam- | Exam- | Exam- |
| Irradiation Mask | ple 1 | ple 2 | ple 3 |
| Material | PET | None | Carbon |
| | | | Dispersion |
| | | | PVA |
| Thickness (μm) | 100 | — | 12 |
| Haze (%) | 0.5 | — | 58 |
| Arithmetic Average | 0.05 | — | 0.30 |
| Roughness (Ra) | | | |
| Oxygen Permeation | 5.1 × | — | 2.8 × |
| Coefficient | 10⁻¹⁴ | | 10⁻¹⁷ |
| (cm³(STP)cm/ | | | |
| (cm² · s · Pa) | | | |
| Ultraviolet | 92 | — | 19 |
| Permeability (%) | | | |
| (365 nm) | | | |

The evaluation results of the anisotropic optical films obtained are shown in Tables 5 through 7 for thickness, haze value, diffusion width, unevenness defect, glare (interference bow), roughness, and presence or absence of non-structural region. It is to be noted that the “thickness” of the anisotropic optical film refers to “the total thickness of the structural region+the non-structural region” in Table 5 and the subsequent tables.

TABLE 5

| Properties of | | | | | |
|---|---|---|---|---|---|
| Anisotropic | Exam- | Exam- | Exam- | Exam- | Exam- |
| Optical Film | ple 1 | ple 2 | ple 3 | ple 4 | ple 5 |
| Thickness (μm) | 95 | 47 | 52 | 50 | 45 |
| Haze (%) | 76 | 66 | 70 | 79 | 65 |
| Diffusion Width (°) | 44 | 41 | 40 | 50 | 40 |
| Unevenness Defect | Yes | Yes | Yes | Slightly | No |
| | | | | Yes | |
| Glare (Interference Bow) | Yes | Yes | Slightly | No | Yes |
| | | | Yes | | |
| Roughness | No | No | No | No | No |
| Non-Structural Region | 3 | 3 | 3 | 2 | 2 |
| (Thickness (μm)) | | | | | |

TABLE 6

| Properties of | | | | |
|---|---|---|---|---|
| Anisotropic | Exam- | Exam- | Exam- | Exam- |
| Optical Film | ple 6 | ple 7 | ple 8 | ple 9 |
| Thickness (μm) | 28 | 30 | 30 | 28 |
| Haze (%) | 69 | 90 | 91 | 92 |
| Diffusion Width (°) | 41 | 56 | 55 | 58 |
| Unevenness Defect | Slightly | No | No | No |
| | Yes | | | |
| Glare (Interference Bow) | Yes | No | No | No |
| Roughness | No | No | Slightly | Slightly |
| | | | Yes | Yes |
| Non-Structural Region | 2 | 2 | 2 | 2 |
| (Thickness (μm)) | | | | |

TABLE 6-2

| Properties of | | |
|---|---|---|
| Anisotropic | Exam- | Exam- |
| optical film | ple 10 | ple 11 |
| Thickness (μm) | 50 | 50 |
| Haze (%) | 72 | 70 |
| Diffusion Width (°) | 38 | 36 |
| Unevenness Defect | Slightly | Slightly |
| | Yes | Yes |
| Glare (Interference Bow) | No | No |
| Roughness | No | No |
| Non-Structural Region | 17 | 2 |
| (Thickness (μm)) | | |

TABLE 7

| | Compar- | Compar- | Compar- |
|---|---|---|---|
| Properties of | ative | ative | ative |
| Anisotropic | Exam- | Exam- | Exam- |
| Optical Film | ple 1 | ple 2 | ple 3 |
| Thickness (μm) | 195 | 188 | 53 |
| Haze (%) | 62 | 47 | 52 |
| Diffusion Width (°) | 31 | 16 | 25 |
| Unevenness Defect | Yes | Yes | No |
| Glare (Interference Bow) | Yes | No | No |
| Roughness | No | No | Slightly |
| | | | Yes |
| Non-Structural Region | 50 | 50 | 30 |
| (Thickness (μm)) | | | |

As shown in Tables 5 through 7, the anisotropic optical films according to the examples have great diffusibility and diffusion widths even with small film thicknesses of 100 μm or less, and in particular, Examples 6 to 9 have great properties with film thicknesses of approximately 30 μm. The reason why great diffusibility and diffusion widths are achieved even with the thin films as just described is believed to be caused by the fact that there is no non-structural region in the cross-section observation (or the non-structural region is extremely thin on the other of 5 μm or less). Furthermore, it is determined that an anisotropic optical film which is excellent in productivity and practicability without any unevenness defect, glare (interference bow), or roughness has been succeeded in being prepared according to Example 7.

On the other hand, the anisotropic optical films according to Comparative Examples 1 to 3 not only fail to achieve satisfactory optical characteristics, but also require useless thicknesses because of the presence of the non-structural region. It is to be noted that the elimination of the non-structural region will result in inferior in terms of productivity and cost.

1. A process for producing an anisotropic optical film of which the diffusibility of transmitted light is varied depending on the incident angle of light, the process comprising:
a light irradiation mask joining step of joining a light irradiation mask with a haze value of 1.0 to 50.0% to a surface of an uncured light-curing resin composition layer; and
a curing step of curing the uncured resin composition layer to form an anisotropic diffusion layer by light irradiation through the light irradiation mask, after the light irradiation mask joining step.

2. The process for producing an anisotropic optical film according to claim 1, wherein the light irradiation mask has ultraviolet permeability, and a resin material for the light irradiation mask comprises at least one of polyolefins, polyesters, poly(meth)acrylates, polycarbonates, polyvinyl acetates, polyvinyl alcohols, polyamides, polyurethanes, polysilicone, polyvinyl chloride, polyvinylidene chloride, polystyrene, polyacrylonitrile, polybutadiene, and polyacetal.

3. The process for producing an anisotropic optical film according to claim 1, wherein the light irradiation mask has surface roughness of 0.05 to 0.50 μm.

4. The process for producing an anisotropic optical film according to claim 1, wherein the light irradiation mask has a thickness of 1 to 100 μm.

5. The process for producing an anisotropic optical film according to claim 1, wherein the light irradiation mask has an oxygen permeation coefficient of 1.0×10⁻¹¹ cm³ (STP) cm/(cm²·s·Pa) or less.

6. The process for producing an anisotropic optical film according to claim 1, wherein the anisotropic diffusion layer comprises a matrix region and a plurality of pillar regions that differ in light refractive index from the matrix region.

7. The process for producing an anisotropic optical film according to claim 1, wherein the light irradiation mask contains fine particles, and the fine particles are 10 μm or less in average particle size.

8. The process for producing an anisotropic optical film according to claim 7, wherein the fine particles comprise at least one or more inorganic fine particles selected from the group consisting of a metal particle, a metal oxide particle, a clay, and a carbide particle.

9. The process for producing an anisotropic optical film according to claim 2, wherein the light irradiation mask has surface roughness of 0.05 to 0.50 μm.

10. The process for producing an anisotropic optical film according to claim 2, wherein the light irradiation mask has a thickness of 1 to 100 μm.

11. The process for producing an anisotropic optical film according to claim 2, wherein the light irradiation mask has an oxygen permeation coefficient of 1.0×10⁻¹¹ cm³ (STP) cm/(cm²·s·Pa) or less.

12. The process for producing an anisotropic optical film according to claim 4, wherein the light irradiation mask has an oxygen permeation coefficient of 1.0×10⁻¹¹ cm³ (STP) cm/(cm²·s·Pa) or less.

13. The process for producing an anisotropic optical film according to claim 10, wherein the light irradiation mask has an oxygen permeation coefficient of 1.0×10⁻¹¹ cm³ (STP) cm/(cm²·s·Pa) or less.

14. The process for producing an anisotropic optical film according to claim 2, wherein the anisotropic diffusion layer comprises a matrix region and a plurality of pillar regions that differ in light refractive index from the matrix region.

15. The process for producing an anisotropic optical film according to claim 2, wherein the light irradiation mask contains fine particles, and the fine particles are 10 μm or less in average particle size.

16. The process for producing an anisotropic optical film according to claim 3, wherein the light irradiation mask contains fine particles, and the fine particles are 10 μm or less in average particle size.

17. The process for producing an anisotropic optical film according to claim 9, wherein the light irradiation mask contains fine particles, and the fine particles are 10 μm or less in average particle size.

18. The process for producing an anisotropic optical film according to claim 15, wherein the fine particles comprise at least one or more inorganic fine particles selected from the group consisting of a metal particle, a metal oxide particle, a clay, and a carbide particle.

19. The process for producing an anisotropic optical film according to claim 16, wherein the fine particles comprise at least one or more inorganic fine particles selected from the group consisting of a metal particle, a metal oxide particle, a clay, and a carbide particle.

20. The process for producing an anisotropic optical film according to claim 17, wherein the fine particles comprise at least one or more inorganic fine particles selected from the group consisting of a metal particle, a metal oxide particle, a clay, and a carbide particle.
